(19) United States
(12) Patent Application Publication
(10) Pub. No.: US 2012/0279642 A1
(43) Pub. Date: Nov. 8, 2012

(54) Static Cling Display Material and Methods

(76) Inventor: Mary K. Wresh, New Brighton, MN (US)

(21) Appl. No.: 13/101,723

(22) Filed: May 5, 2011

(51) Int. Cl. B32B 33/00; B32B 37/00

(52) U.S. Cl. 156/249; 428/40.1

(57) ABSTRACT

A roll, sheet or individual elements of static cling display material including a static cling substrate that has a pressure sensitive adhesive layer, which is preferably releasably mounted to a backing layer to protect the adhesive layer until use. The static cling display material can be attached to a display to removably secure the display to a surface. In certain embodiments, the static cling display material is configured such that the display can be viewed from two sides of a transparent display surface, such as a window.

### BACKGROUND OF THE INVENTION

The present invention relates to static cling display materials that can be attached to a display to removably secure the display to a surface and methods of using same.

### DESCRIPTION OF THE RELATED ART

There are many known applications in which tape is placed on receiving surfaces such as windows, mirrors and glass objects to bond things to those surfaces. In many of these instances, it is desirable to eventually remove the tape from these surfaces. Often times, the tape has a strong adhesive which leaves a sticky residue that requires time and effort to remove. Sometimes, a special tool, such as a razor blade or solvent, adds additional time and expense to using tape along with the risk of damaging the surface in attempts to remove residue.

It is common for businesses to print their own computer generated posters and signage to be displayed in windows, entryways and numerous other locations at their business, thus allowing them a freedom to display such things as holiday hours, daily specials, weekly sales, public/employee entrances, and other informational displays or advertisements. The ability to print their own posters or signage allows a business to convey information on a steady and creative basis as needed without having to rely on a professional printer which is very time consuming and expensive. Consequently, printed paper is typically hung with adhesive tape that, once again, comes the inconvenience of the residue left behind by the tape.

The present invention addresses limitations associated with the related art and provides solutions to the problems inherent thereto.

### SUMMARY OF THE INVENTION

The preferred static cling display material has a static cling substrate 12 having first and second sides 22, 24. The static cling substrate 12 is coated on one side 22 with an adhesive or the like. The substrate preferably includes a layer of polyvinylchloride static cling material having a substantially transparent adhesive material on one side 22 that can be secured to a display such as a poster, sheet or the like. Then, the second side 24 can be secured to a display surface such as a window or a smooth finished surface such as those found on a refrigerator, dry-erase board or the like to removably hang the display on the display surface. In certain embodiments, a peel away backing protects the adhesive until use. One objective is to be able to hang posters/signage on glass or otherwise smooth surfaces without the sticky residue of adhesive tape, which is often left behind when a display is attached with tape. The adhesive is preferably applied to one side of the display while the cling side can be adhered to the display surface. With the cling side removably adhering to the display surface, there would be no residue left behind once the signage is removed. Furthermore, the display can easily be adjusted as necessary; removing it and re-positioning it. Under many applications, the display may also be reused, which can result in cost savings. Because it is easily removed, the display can be removed and stored and then put up another time.

Another object of the present invention is to provide multiple sized embodiments and configurations that are even, perhaps, modifiable by a user to provide much creative freedom pertaining to shapes and sizes of signage and how the static cling display material can be dispensed. The present invention allows a user to attach a poster to the adhesive backed cling material so that the cling material is attached to the poster by the adhesive backing, then the cling material can be removably attached to a window on the other surface.

The poster or other display might even be two sided and the preferred embodiments are configured so that the adhesive backed cling material does not substantially obstruct the display so that the preferred embodiments can be used to display advertising on both sides of a window or other transparent surface at the same time.

These and various other advantages and features of novelty which characterize the present invention are pointed out with particularity in the claims annexed hereto and forming a part hereof. However, for a better understanding of the invention, its advantages and objects obtained by its use, reference should be made to the drawings which form a further part hereof, and to the accompanying descriptive matter, in which there is illustrated and described a preferred embodiment of the present invention.

### BRIEF DESCRIPTION OF THE DRAWINGS

FIG. 1 is a perspective view of one preferred embodiment of the present invention, that being, a continuous roll of static cling display material 10;

FIG. 2 is a cross-sectional view of the continuous roll of static cling display material 10 as viewed along line 2-2;

FIG. 3 is a front view of a display D having portions 18 of the a continuous roll of static cling display material 10 of FIGS. 1-2, attached thereto;

FIG. 4 is a front view of a display D having strips 20 of the a continuous roll of static cling display material 10 of FIGS. 1-2, attached thereto;

FIG. 5 is a perspective view of portions 18 being cut to a custom size from the continuous roll of static cling display material 10 by scissors S;

FIG. 6 is a front view of a second preferred embodiment of the present invention, that being a sheet of static cling display material 110;

FIG. 7 is a front view of another preferred embodiment of the present invention, that being a border of static cling display material 210;

FIG. 8 is a front view of yet another preferred embodiment of the invention, that being a sheet 310 of individual elements of static cling display material 318;

FIG. 9 is a front view of the individual elements of static cling display material 318 of FIG. 8, secured to display D2;

FIG. 10 is a front view of yet another preferred embodiment of the invention, that being a sheet 410 of individual elements of static cling display material 418;

FIG. 11 is a front view of the individual elements of static cling display material 418 of FIG. 10, secured to display D3; and

FIG. 12 is a front view of the display D2 of FIG. 9 attached to a window W with individual elements of static cling display material 318.

### DETAILED DESCRIPTION OF THE PREFERRED EMBODIMENTS

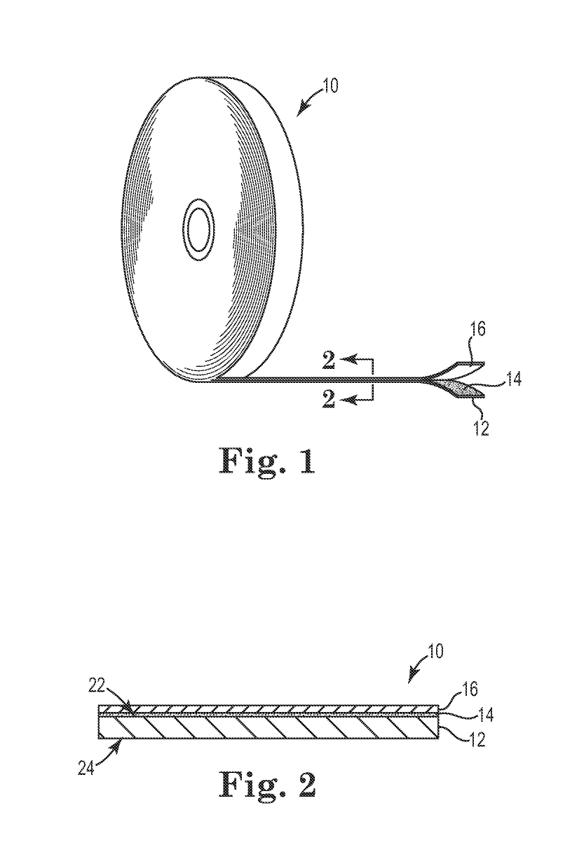

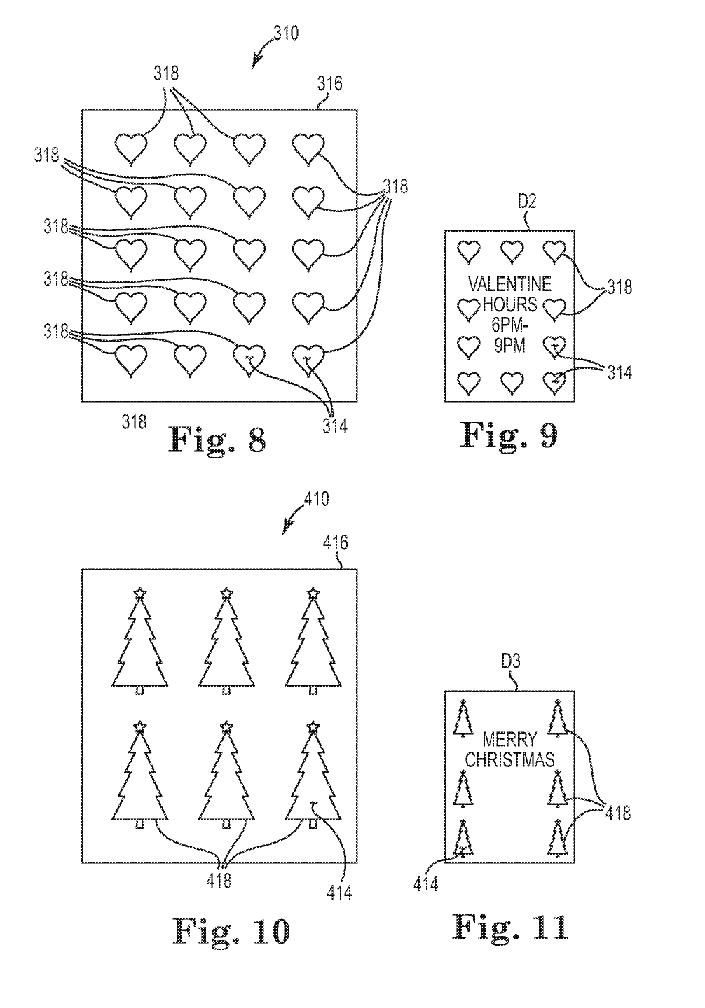

Preferred embodiments are illustrated in FIGS. 1-12. FIGS. 1-2 illustrate a continuous roll of static cling display material. The roll of static cling display material 10 includes a static cling substrate 12 that has a pressure sensitive adhesive layer 14, which is preferably releasably mounted to a backing layer 16 to protect the adhesive layer 14 until use. The preferred static cling substrate 12 is a formulation of polyvinyl chloride to which a large amount of plasticizer has been added as is known in the art of making static cling material. The polyvinyl chloride is calendared to give it a smooth finish that will provide a good cling to other smooth surfaces. When the static cling substrate 12 is applied to a clean smooth glossy display surface, it adheres firmly to the surface without having to apply the adhesive directly to the surface.

In preferred embodiments the adhesive layer is a single coat of either a solvent or a water based acrylic adhesive. These synthetic acrylic adhesives are preferably made from derivatives (mainly esters) of acrylic, methacrylic, and cyanoacrylic acids; preferably acrylic adhesives made from monomeric esters and solutions of polyacrylates in the monomers, in inert organic solvents, or in mixtures of the monomers and such solvents or in aqueous emulsions. In alternate embodiments, modifiers are added to acrylic adhesives to control the viscosity of the adhesives and the elasticity of the hardened compositions and to improve the strength of bonding and the resistance to high temperatures. Such alternate modifiers include vinyl acetate, styrene, butadiene, and other monomers; phenol-formaldehyde, urea-formaldehyde, and epoxy resins; cellulose esters; rubbers; fillers; plasticizers and the like. Further alternate acrylic adhesives include acrylic adhesives containing polyisobutylene that are used to make sticky films and patches.

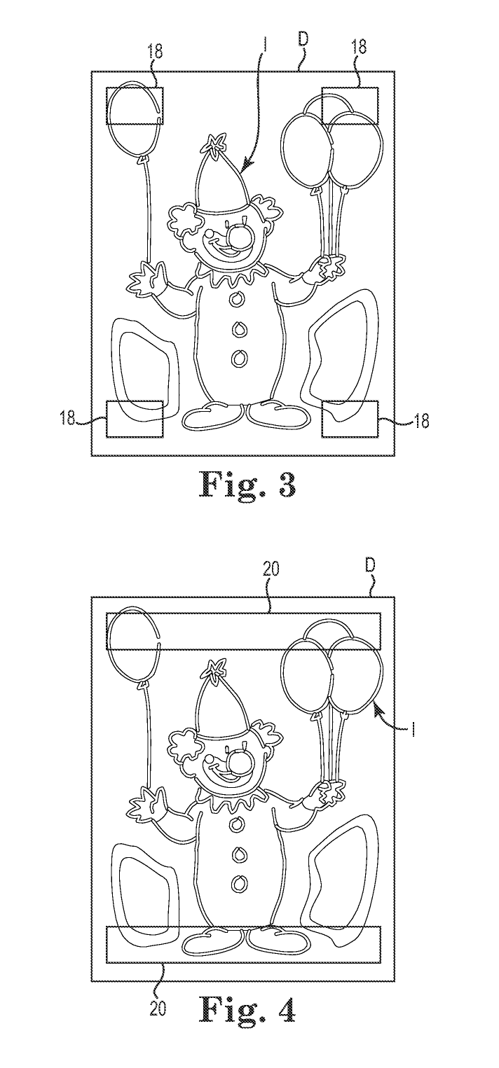

The roll of static cling display material 10 is a preferred method of dispensing the static cling display material because a roll can be unrolled and dispensed in a variety of lengths to create unlimited mounting options as needed by the end user. As is generally illustrated in FIGS. 3-5, the roll of static cling display material 10 can be cut to portions 18 or strips 20 of the desired size with scissors S or the like. The adhesive layer 14 sticks to the backing layer 16 until the user removes the backing layer 16, which can then be discarded. The adhesive layer 14 can then be attached to the display D, such as a poster, sheet of paper or the like. Thus, the static cling substrate 12 will then remain free to attach to any display surface (e.g. glass, window, mirror or the like) without damage to the surface or leftover residue from what would typically be left behind if the display was secured to the display surface with an adhesive tape. The static cling substrate 12 can be applied or removed repeatedly from the display surface, as necessary, for purposes such as cleaning the display surface or moving the display D to another display surface. Furthermore, the portions 19 or strips 18 are preferably configured to be substantially transparent and positioned on the display D such that the portions 18 and strips 20 do not substantially obstruct the display image I.

In preferred embodiments, the thickness of the static cling material will be from about 4.0 to about 12.0 mils or mm, more preferably about 7 mils, especially for a basic white or a clear static cling.

It will be understood that the term “display surface” can include a wide variety of surfaces in which static cling materials can stick or adhere. Such surfaces include, but are not intended to be limited to glass, mirrors, windows, refrigerators, stainless steel, brass and the like.

It will further be understood that the term “display” can include a wide variety of items in which one desires to be displayed. Such displays can include, but are not intended to be limited to posters, signage, papers and the like.

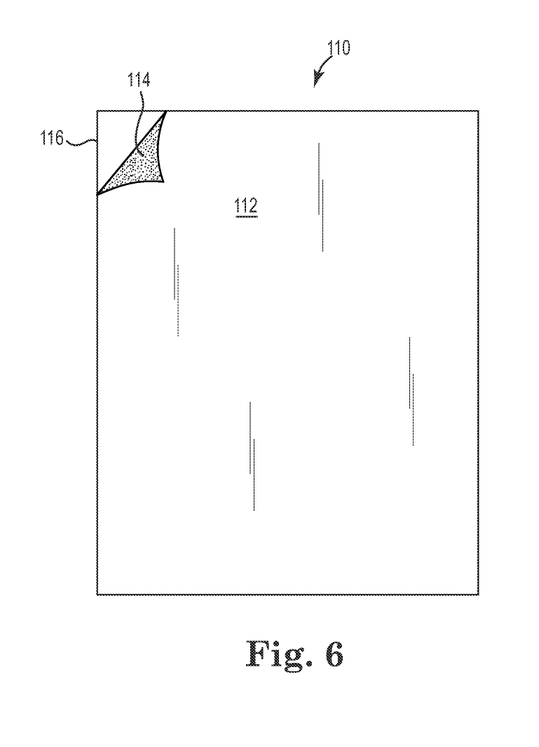

Now also referring to an alternate embodiment, which is illustrated in FIG. 6. The static cling display material of FIG. 6 is dispensed in sheet form 110 versus the roll of FIGS. 1-5. As with the previous embodiment, the sheet of static cling display material 110 includes a sheet of static cling substrate 112 having an adhesive 114. Preferably, as with prior embodiments, the adhesive 114 has a backing 116 that can be removed and discarded. The adhesive 114 secures a display to the static cling substrate 112 and the static cling substrate 112 can be attached to the display surface. This configuration allows for a display to be reused as often as necessary for things that may need repeated advertising on a different day or in a different week such as daily and weekly specials, regular business hours, holiday hours, sales of the week, for example. The display can be stored away when not in use and re-hung as desired.

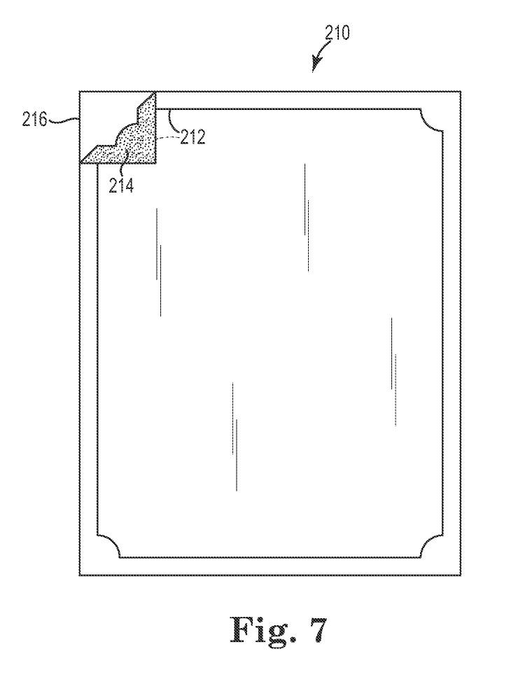

As shown in FIG. 7, in one preferred embodiment, the static cling display material is configured to be a border 210 that can be secured to a display. The border of static cling display material 210 is preferably arranged and configured to be affixed proximate the outer most edges of the display (see also, FIG. 4). Again, the adhesive 214 would apply to the display and the static cling 212 to the display surface. The static cling display material 210 of FIG. 7 is not limited to any shape, size, style or color so they may be very helpful in dressing up a certain display to better advertise what is needed. Examples of this might be an orange border to advertise a Halloween party or a red, white and blue border to advertise the Fourth of July.

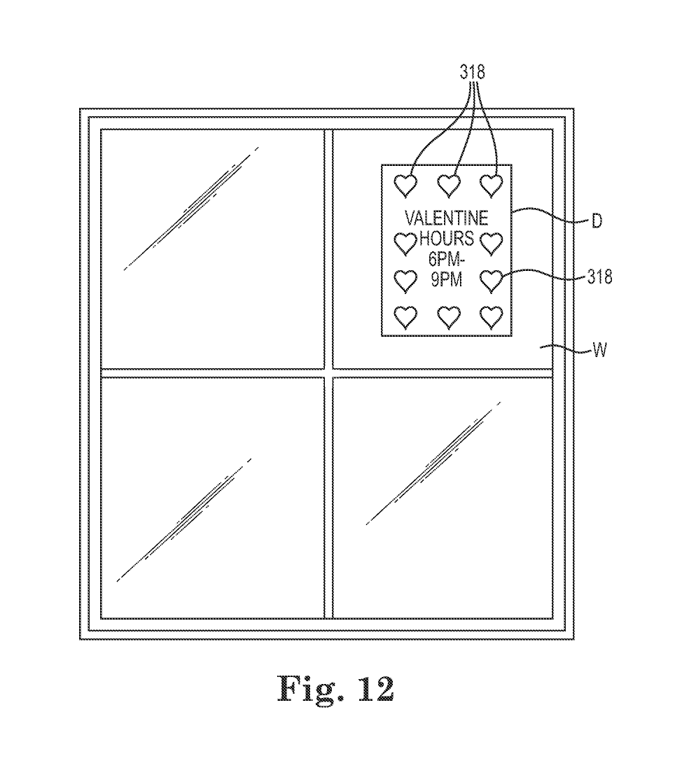

Now also referring to yet a further embodiment that is illustrated in FIGS. 8-12. FIGS. 8-12 illustrate individual elements of static cling display material 318, 418 can that can be peeled from a sheet backing 316, 416, each static cling element having first and second sides (having a cross section as is illustrated and described generally with respect to FIG. 2). As with previously described embodiments, the first side having an adhesive layer 314, 414 secured on the backing sheet 316, 416. To use the individual elements of static cling display material 318, 418, a user can peel off one static cling element 318, 418 from the sheet backing 316, 416, then apply the adhesive side to the display D2, D3. Then, the display D2, D3 can be hung on a generally smooth, glossy display surface, such as a window W, and removed or adjusted as desired, similar to the discussion for previous embodiments. As is generally illustrated in FIGS. 8-11, it is envisioned that the individual elements of static cling display material 318, 418 may be made into many different shapes or designs to add an esthetic appeal to the display D2, D3. The individual static cling elements would be made of the same material as previously disclosed embodiments. For example, each individual element 318, 418 preferably includes a static cling substrate 314, 414 having an adhesive layer (see also FIG. 2) which is secured to a removably backing 316, 416 until use. Such a configuration enables a display D2, D3 to be removably attached to a display surface W as is generally illustrated in FIG. 12, for example.

### Example 1

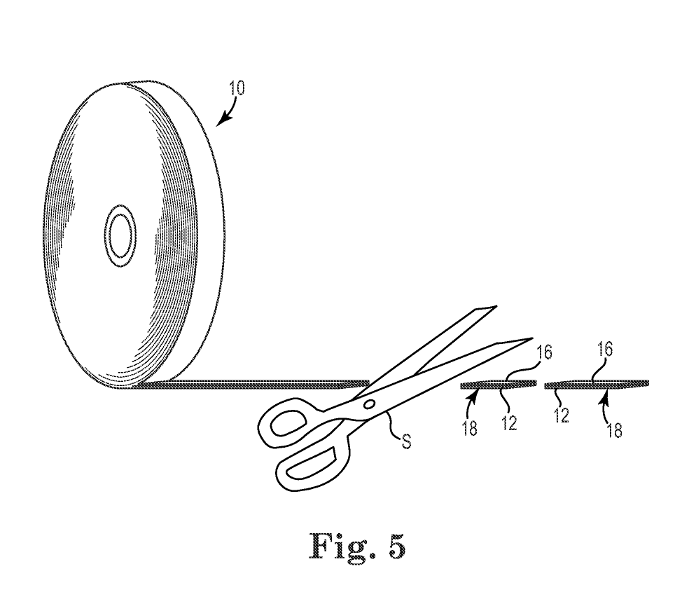

A continuous roll of static cling display material 10 that can be cut into portions 18 or strips 20 as shown in FIGS. 1 and 5.

### Example 2

A sheet of static cling display material 110 as shown in FIG. 6.

### Example 3

A border of static cling display material 210 as shown in FIG. 7.

### Example 4

A sheet 310 of individual elements of static cling display material 318. Optionally, such individual elements of static cling display material 318 can be of a design such as a heart, Christmas tree, or the like as shown in FIGS. 8-12.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A static cling display material for securing a display to a display surface, the static cling display material comprising:
a static cling substrate having first and second sides;
a layer of adhesive on the first side of the static cling substrate;
a backing covering the layer of adhesive;
wherein the backing can be removed to expose the layer of adhesive such that the layer of adhesive can adhere the display to the static cling substrate;
wherein the display can be viewed when looking at the second side of the static cling substrate when the display is adhered to the layer of adhesive.

2. The static cling display material of claim 1, wherein the static cling display material is in the form of a roll.

3. The static cling display material of claim 1, wherein the static cling display material is in the form of a sheet.

4. The static cling display material of claim 1, wherein the static cling display material is in the form of a border.

5. The static cling display material of claim 1, wherein the static cling substrate is a plurality of static cling substrate elements secured to the backing.

6. The static cling display material of claim 1, wherein the layer of adhesive is substantially transparent.

7. A method of posting a display, the method comprising the steps of:
providing a display;
providing a static cling display material including:
a static cling substrate having first and second sides;
a layer of adhesive on the first side of the static cling substrate; and
a backing covering the layer of adhesive;
removing the backing;
pressing the display onto the layer of adhesive; and
pressing the static cling substrate onto a generally smooth surface to removably secure the display to the generally smooth surface.

8. The method of claim 7, further comprising the step of selecting a desired amount of static cling display material and separating the desired amount of static cling display material from the rest of the of static cling display material.

9. The method of claim 8, wherein the step of selecting a desired amount includes unrolling the static cling display material.

10. The method of claim 7, wherein the static cling display material is sized and configured to be a border, proximate edges of the display.
